(19) United States
(12) Patent Application Publication
(10) Pub. No.: US 2006/0003079 A1
(43) Pub. Date: Jan. 5, 2006

(54) METHOD OF MAKING A HEALTH SUPPLEMENT

(76) Inventor: Ibnsina Karkenny, Roanoke, VA (US)

Correspondence Address: KELLY LOWRY & KELLEY, LLP, 6320 CANOGA AVENUE, SUITE 1650, WOODLAND HILLS, CA, 91367, US

(21) Appl. No.: 11/161,055

(22) Filed: Jul. 21, 2005

Related U.S. Application Data
(63) Continuation-in-part of application No. 10/777,539, filed on Feb. 11, 2004.

(51) Int. Cl. A23L 1/32

(52) U.S. Cl. 426/614

(57) ABSTRACT

A process for making a health supplement from an egg having a yolk and an egg white includes separating the yolk from the egg white. At least a portion of the yolk is placed in a closed heating vessel and the yolk is heated within the range of 160 to 220 degrees Celsius to evaporate an oil therefrom. The evaporated oil is condensed and water content removed from the condensed oil to form the health supplement. The health supplement aids in at least one of the following: protecting treated surfaces, reducing oxidative stress, increasing efficiency of probiotic activity, reducing effects of acidosis, and maintaining blood pH.

### BACKGROUND OF INVENTION

The invention relates generally to a health supplement. More particularly, the invention relates to a health supplement derived from egg yolk.

There is a great need for a health supplement that can be applied to a wide range of uses. Over the years, many types of health supplements or products have been used to aid a user in achieving health benefits. However, such health supplements or products are often made from synthetic or otherwise processed ingredients and require complicated procedures during formulation. Even some health supplements derived from natural ingredients, such as egg yolks, require that those eggs be obtained from special sources prior to preparation. For example, U.S. Pat. No. 6,803,035 discloses an anti-diarrheal and method for using the same. However, this method requires that the egg product specifically be obtained from a hyper-immunized avian. This requires additional cost and effort in order to ensure that the egg comes from a hyper-immunized avian and is suitable for use.

While methods of preparing egg yolks for use as a health supplement, such as the one described above, may provide a heath supplement for use in a variety of applications, such methods can always be improved to simplify the process of making such supplements.

Accordingly, there is a need for a simplified method of making an egg-derived health supplement. There is a further need for an egg-derived health supplement where the egg does not have to come from any special source. The present invention satisfies these needs and provides other related advantages.

### SUMMARY OF THE INVENTION

The present invention provides a simplified method of making an egg-derived health supplement.

An embodiment of the present invention, in the form of a process for making a health supplement from egg(s) having a yolk and egg white. The process starts with separating the egg yolk from the egg white. At least a portion of the yolk is placed in a closed heating vessel and the yolk is heated within the range of 325 to 425 degrees Fahrenheit (approximately 160 to 220 degrees Celsius) to evaporate an oil therefrom. The oil can also be evaporated by heating the portion of yolk within the range of 350 to 400 degrees Fahrenheit (approximately 175 to 205 degrees Celsius).

The evaporated oil is condensed and water content removed from the condensed oil to form the health supplement. The health supplement aids in at least one of the following: protecting treated surfaces, reducing oxidative stress, increasing efficiency of probiotic activity, reducing effects of acidosis, and maintaining blood pH. The condensed oil is heated within the range of 212 to 300 degrees Fahrenheit (approximately 100 to 150 degrees Celsius) to remove at least a portion of water content.

As noted above, the yolk is heated in the closed heating vessel within the range of 350 to 400 degrees Fahrenheit (approximately 175 to 205 degrees Celsius).

The health supplement is administered to a mammal. The supplement can be administered to the mammal through various routes selected from the group consisting of one or more of the following: oral, buccal, sublingual, nasal, topical, transdermal, opthalmic, vaginal, rectal, intravesical, pulmonary, intra-arterial, intravenous, intradermal, intramuscular, subcutaneous, intraperitoneal, intrathecal and intraocular.

The supplement can be delivered to the mammal using a metered dose inhaler, a nebulizer, an atomizer, a spray bottle, or a nasal pump.

One drop of the condensed oil can be diluted with five gallons of water to form a mixture. An additive can be placed into the mixture to bond with the oil.

Other features and advantages of the invention will become more apparent from the following detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 illustrates making a paste and an oil from egg yolk; and

FIG. 2 illustrates making a health supplement from the paste and/or oil derived from egg yolk.

### DETAILED DESCRIPTION OF THE PREFERRED EMBODIMENTS

The present invention provides a method of making an egg-derived lubricant or additive that eliminates the use of solvents during the process and a simplified method of making an egg-derived lubricant or additive. The present invention also provides a method by which the egg-derived lubricant or additive can be adapted as a health supplement suitable for use by a mammal.

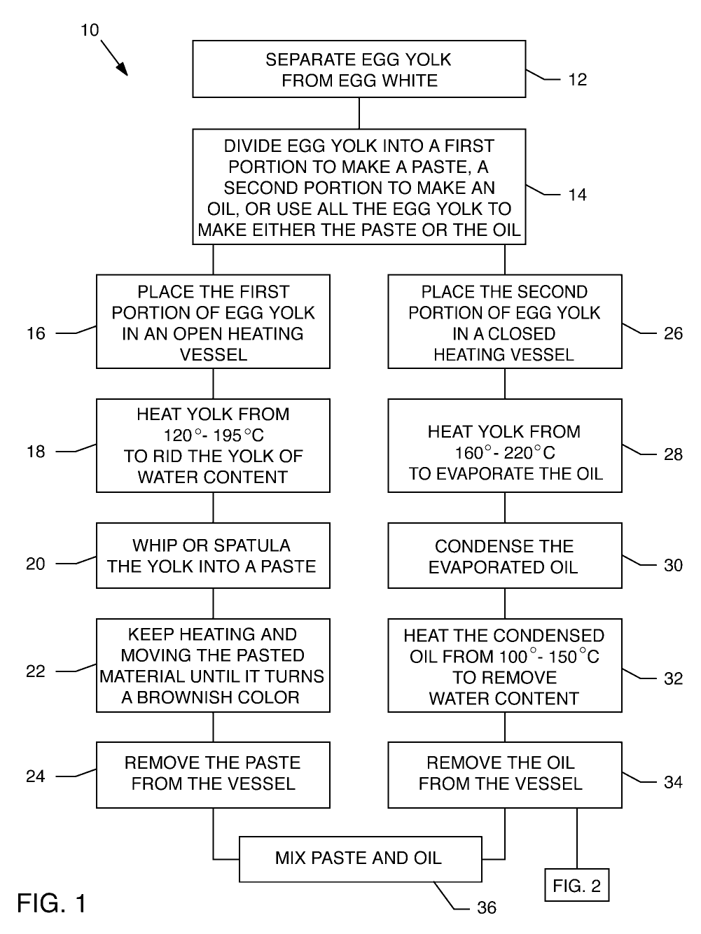

As shown in the drawings for purposes of illustration, an embodiment of the present invention resides in a method of making a paste and/or an oil for lubrication that is derived from eggs. As illustrated in FIG. 1, the process 10 of making a lubricating additive starts with eggs. An ordinary chicken egg (organic or otherwise) includes a yolk and egg white. A number of eggs may be selected appropriate to the amount of paste and/or oil desired.

The egg yolk can be separated 12 from the egg white using a number of methods. One method involves breaking the egg shell and running the egg across an inclined screen where the egg white runs through the screen while the egg yolk slides toward the bottom of the inclined screen and into a holding apparatus for further processing, but leaves the egg yolk sack. However, hard boiling the egg to a very hard boil allows the user to break open the egg and remove the egg yolk and the egg yolk sack with little to no loss of egg yolk. Also, boiling the egg(s) in a container until the egg(s) are hard-boiled makes it possible to remove the yolk sack more easily; leaving the yolk very pure of starch. The entire yolk is used and the egg white and egg shell may be discarded.

The process includes a first sub-process for forming a paste from the heated yolk and a second sub-process for forming a lubricating oil from the heated yolk. To this end, the yolk is divided 14 into a first portion to make the paste and a second portion to make the lubricating oil. Alternatively, all of the yolk can be used to make the paste or all of the yolk can be used to make the lubricating oil.

During the process of making the paste, the first portion of egg yolk is placed 16 in an open heating vessel as part of the heating process. The yolk is heated 18 from 250 to 375 degrees Fahrenheit (approximately 120 to 195 degrees Celsius), preferably 300 to 350 degrees Fahrenheit (approximately 150 to 175 degrees Celsius), to form the paste. As the yolk is heated, water content is removed from the yolk by heating the yolk at 325 degrees Fahrenheit (approximately 160 degrees Celsius).

When the yolk is completely dry of all moisture content, the heat is increased and a stirring device including, but not limited to a whip, spatula or the like is used to mix 20 the egg yolk to form the paste. The paste is then browned through heating and stirring until the paste turns a dark reddish brown (but not blackened brown) color. The turning of the color is rapid. The mixing exposes the egg yolk to the heating surface of the heating vessel for even heating. The yolk should be mixed rapidly in order to prevent the paste from burning and stirred constantly until the paste achieves the desired color 22. Once the yolk-derived paste is the desired color, the paste is immediately removing the heat (by removing the heating vessel from the heat source) and/or removing the paste from the heating vessel. When properly heated and mixed, the yolk-derived paste will have a powdery consistency. If the egg yolk is burned anytime in the process, an oil will form and the egg yolk will turn black from the residual carbon.

The time of exposure of the yolk to heat is dependent on the amount of yolk-derived paste material being made. For example, one quantity of yolk can be heated at a temperature of approximately 250 degrees Fahrenheit (approximately 120 degrees Celsius) for approximately 3 hours in order to achieve a golden brown color. At this point the paste is still not complete as the material only has a light golden-brown color. When the egg yolk dries and breaks up into an oily powder (due to the water or moisture content being removed), the user takes a flat spatula or whip and breaks the yolk apart and mixes the yolk rapidly while turning the heat up to 375 degrees Fahrenheit (approximately 195 degrees Celsius). After awhile, the yolk achieves throughout the desired dark brown color (but not black) as well as a paste or putty-like consistency. The user then immediately removes 24 the paste material from the heating vessel or turns off the heat and keeps mixing the material until the temperature drops below 300 degrees Fahrenheit (approximately 150 degrees Celsius).

In the alternative, the process of making the paste can be accomplished on an industrial scale by passing the egg yolk across a direct heat of 375 degrees Fahrenheit (approximately 195 degrees Celsius), mixing unfinished material in and out of the heating surface until the process comes to completion.

During the process of making the lubricating oil, the second portion of egg yolk is placed 26 in a closed heating vessel. The yolk is heated 28 within the range of 325 to 425 degrees Fahrenheit (approximately 160 to 220 degrees Celsius), or preferably 350 to 400 degrees Fahrenheit (approximately 175 to 205 degrees Celsius), to form the oil. If the yolk were heated in an open heating vessel, part of the oil would evaporate and re-condense onto cold surfaces. However, in the closed heating vessel, the oil evaporates from the oil as the yolk is heated but the evaporating oil can be sent into a condensing coil and recaptured.

As the yolk is heated in the closed heating vessel, a paste such as the one described above begins to form. However, the heating of this paste over 400 degrees Fahrenheit (approximately 205 degrees Celsius) causes the paste to turn into a carbon byproduct even as substantially all of the oil and water evaporate from the heated yolk. The evaporated oil and water rise in the closed heating vessel and passes through an opening in the heating vessel to a pipe which carries the evaporated oil and water to a condensing unit to capture the evaporated oil and water. In this way it makes no difference if the egg white is removed or not, as the egg white would just be a residue on the bottom of the heating vessel along with the carbon black egg yolk residue.

In the condensing unit, the evaporated oil is condensed 30 or cooled back to a liquid state. This condensed liquid will have water from the yolk mixed with it. It is necessary to remove the water content from the condensed liquid by heating the condensed liquid. The condensed liquid is moved to the heating vessel and heated 32 slowly from 212 to 350 degrees Fahrenheit (approximately 100 to 175 degrees Celsius), or preferably 212 to 300 degrees Fahrenheit (approximately 100 to 150 Celsius), so that there is sufficient heat to evaporate the water but not enough heat to evaporate the oil. Overheating the condensed liquid will carry the yolk-derived oil up with the water vapor. The evaporating oil is volatile and may catch fire. Caution must be taken to avoid exposing the oil vapor to an open flame. Once the water content is removed, the oil is removed 34 from the heating vessel/condenser assembly.

Alternatively, the oil can be obtained without having to evaporate and condense the oil. The egg yolk can be heated in an open vessel and, as the yolk is heated, the oil separates from the bulk material leaving a putty-like carbon material. The oil can then be squeezed from the putty which hardens and turns brittle as the putty cools to room temperature.

At the end of the process, the paste and the lubricating oil are mixed 36. The paste and lubricating oil can be mixed in different ratios for various viscosity requirements. Alternatively, the paste and oil can be made but not combined. For example, the oil can be used in combination with other lubricants without the paste and the paste can be used in combination with other lubricants without the oil.

This yolk-derived additives can then be added to the desired conventional lubricating oil of choice (depending on the application requirements). There are a wide range of applications that this material can be used. The yolk-derived materials may be used in a number of ways including, without limitation, as an additive for lubricants, paints, lacquers, polish, cosmetics, and other oil-based materials. In one application, the yolk-derived paste can be washed with soap and water, dried, and then added to a radiator to improve the release of heat in the radiator.

The yolk-derived paste and yolk-derived oil additives provide noticeable improvements when used including, without limitation, lowered friction, lowered operating temperature, increased gas mileage, cleaner oil, decreased carbon deposits, cleaner burning, and oil stabilization.

Many different factors including, without limitation, viscosity and quantity, are taken into account when using this yolk-derived material in different applications. For example, the paste and oil affect the viscosity of the substance to which the paste and/or oil is added. The oil derived from the egg yolk makes the lubricant to which the oil is added run thinner while the paste derived from the egg yolk gives body to the lubricant to which the paste is added. The amount of paste and/or oil added to a substance depends on the quantities involved. In general, one part oil is derived from the yolk of one large egg and one part oil is derived from the yolk of one large egg. For example, in one formulation, one part yolk-derived oil and one part yolk-derived paste were added to 4 to 5 quarts of a conventional oil. For larger quantities of conventional oil, a user needs to add proportional amounts of yolk-derived oil and/or yolk-derived paste.

In situations where purity is not an issue, the paste may be prepared by separating the egg yolk and egg white without removing the egg yolk sack. Once the paste is made using the steps outlined above, and added to the desired lubricant or other material, the lubricant or other material can be passed through a filter and the contaminant (i.e., egg yolk sack) can be removed.

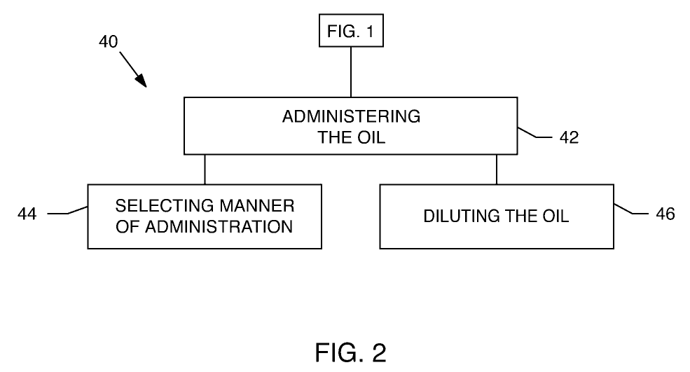

As seen in FIG. 2, another embodiment of the present invention resides in a method of making a health supplement from oil derived from eggs 40 described above in FIG. 1. The health supplement is administered 42 to a living subject that includes, without limitation, mammals, reptiles, avians, amphibians, fish, invertibrates or the like.

As illustrated in FIG. 1, the process starts with separating the egg yolk from the egg white. At least a portion of the egg white is left in with the egg yolk (depending on the consistency desired, from just leaving the yolk sack and tailings to using the whole egg). The optimum amount of egg white to be used with the yolk is the small amount left adhering to the yolk sack and tailing. Any number of eggs may be used at any single time in the closed heating vessel, depending on the quantity of oil desired to be derived from the eggs. For example, at least a dozen eggs may be used to derive a certain quantity of oil from the eggs. The egg yolks should be put in an open container to enable a more accurate heating. The container is then placed in the closed heating vessel (air tight to prevent leakage) and heated in the range described above. The closed heating vessel has a pipette which allows vapors from the heating vessel to escape. This pipette must be suitable in size and length to accommodate the heating vessel for optimum condensation of the evaporated oil (i.e., the condensation of the vapor occurs in the pipe). The vapor re-condenses immediately upon leaving the heating vessel. When the temperature reaches the point when the liquid oil drips out of the pipette into a semi-open container, the temperature is held steady throughout the process. Upon leaving the pipette, the liquid oil in the semi-open container is carefully monitored for consistency. The temperature of the liquid oil in the container is held steady at the temperature where the liquid leaves the pipette. The liquid is kept in the container for approximately one minute for complete cooking of the oil (the longer the oil stays in the container, the thicker (i.e., more viscous) the oil becomes). Preferably, the liquid is kept as light as possible although some applications may require a heavier liquid. When the liquid in the container is suctioned out of the container before it is ready, the liquid pops and crackles. When the liquid in the container is kept in the container longer than the desired obtainable consistency, the liquid gets thicker (i.e., more viscous) than desired. It is preferred to keep the liquid from becoming so thick that the liquid no longer has the consistency of being readily absorbed by the living subject. At this stage, the liquid is suitable to be used as a lubricating oil additive (although the lighter oil can be used in lubricating applications, it is preferred to thicken the oil for most applications). When the oil is siphoned out of the container, there is also a watery liquid that accompanies the oil. At least a portion of this condensed water content is removed by use of a reciprocating funnel. This water liquid is reciprocated out and kept for future potential. On the upper level of capture and directly above the container is a vacuum hood leading to a tube/pipe which carries the remaining vapor up to the next level of condensation. The vapor is sent through the tube/pipe and the tube/pipe is cooled to extract the remainder. The goal is to capture as much of the vapor as possible. When no more oil drips out, the process is done.

The egg yolk-derived health supplement is useful as a homeopathic remedy. The supplement can be introduced into a body in a number of ways: evaporated and breathed in; rubbed on the skin or otherwise placed in contact with a selected body tissue; and consumed orally.

The benefits of contact with this egg yolk-derived health supplement are many. When the supplement is inhaled, the supplement relieves pressure in the lungs. The supplement allows for moisture to return to the lungs and helps one to cough out contaminants. When taken internally, the supplement increases energy levels. When the supplement is rubbed on or otherwise placed in contact with body tissues, the supplement helps the blood kill bacteria on contact. When the supplement is placed in water, bacteria can no longer thrive. The supplement produces noticeable effects such as increasing oxygen levels in the blood, increases speed of clotting when one gets a cut in the skin, helps the body fight infections, increases oxygen levels, assists in memory retention, decreases the severity and number of headaches, increases speed of healing and a host of many other benefits.

There are many individuals suffering from various ailments who can benefit from this egg yolk-derived supplement. Diabetics benefit from the supplement in many ways: scars that never seemed to heal begin to disappear; dry skin becomes softer and healthier; feet become less dry and subject to cracking; blood circulation to extremities improves; insulin use becomes more easily controlled; and dieting becomes more manageable. Smokers can also benefit from the supplement: long time smokers, when they inhale the supplement, cough out contamination and breath easier and experience increased energy levels. Arthritis sufferers also can benefit from the supplement: pain from inflamed tissues eases; increased energy levels are experienced; and swelling of arthritic tissues is lessened.

White blood cells, when they pickup free radicals, harden and get caught in muscle tissue such as in heart muscle. Viruses suppress the immune system by causing the white blood cells to harden before the white blood cells can surround and encompass them, so it takes more white blood cells to do the job. This makes the cell cluster bigger to be removed by the body. The supplement lubricates the blood by keeping white blood cells from hardening.

The supplement increases efficiency of probiotic activity and helps the body maintain a blood pH in the range of 7.4 and reduces the ill effects of acidosis.

Generally, even a healthy person is not as healthy as they think. The instant supplement reduces oxidative stress and one drop of the supplement every month is sufficient to help maintain a low oxidative state. Persons with reduced immune systems will see a dramatic lift with the administration of 5 drops of the supplement. As a preventative, a single drop of the supplement per week provides reduction of oxidation.

The supplement helps to increase blood flow. In persons with long term disorders, the supplement must not be given in more than one drop per week as too much of the supplement too fast will cause an overload of cleansing to the internal organs responsible for removing debris from the body.

The supplement is readily absorbable into the body. Radical cells are cells that have no function other than to multiply for reason other than normal metabolic processes. Radical cells absorb the supplement, thereby cutting off the supply of food to those radical cells. Immediately upon inhaling the supplement, for example, oxygen levels in the blood stream rise slightly. Cells that have outlived their normal recognizable metabolic function, and therefore no longer a viable integral part of the metabolism, are more easily recognized by the body's disposal mechanisms.

The manner of administration of the supplement may be selected 44 from a number of various routes that include, without limitation, oral, buccal, sublingual, nasal, topical, transdermal, opthalmic, vaginal, rectal, intravesical, pulmonary, intra-arterial, intravenous, intradermal, intramuscular, subcutaneous, intraperitoneal, intrathecal and intraocular delivery.

Various devices may be used to assist in delivering the health supplement to the subject including, without limitation, canula, straw, spoon, syringe, eye dropper, metered dose inhaler, nebulizer, atomizer, spray bottle, nasal pump or the like. The health supplement can be applied by hand and/or applied to the subject's body directly from a container the supplement is stored in. In an alternative, the health supplement can be dried into a powder and formed into a pill using conventional methods. This pill can include an enteric coating.

The health supplement can be further adapted for a particular method of chosen to deliver the supplement to the subject's body. For example, one drop of condensed oil can be diluted with five gallons of water to form a mixture 46. A flavoring additive (e.g., sugar, sweetener, cream, milk or the like) can be placed into the mixture to bond with the oil should the subject desire to take the supplement orally. A subject need only take a few drops of the diluted oil per week.

The egg-derived oil may be used for a variety of other purposes including, without limitation, cleaning an aquarium because when the oil is put in aquariums/fish tanks, the water clears up.

The above-described embodiments of the present invention are illustrative only and not limiting. It will thus be apparent to those skilled in the art that various changes and modifications may be made without departing from this invention in its broader aspects. Therefore, the appended claims encompass all such changes and modifications as falling within the true spirit and scope of this invention.

What is claimed is:

1. A process for making a health supplement from an egg having a yolk and an egg white, comprising:
separating the egg yolk from the egg white;
placing at least a portion of the yolk in a closed heating vessel;
heating the yolk within the range of 160 to 220 degrees Celsius to evaporate an oil therefrom;
condensing the evaporated oil; and
removing at least a portion of water content from the condensed oil to form the health supplement;
wherein the health supplement aids in at least one of the following: protecting treated surfaces, reducing oxidative stress, increasing efficiency of probiotic activity, reducing effects of acidosis, and maintaining blood pH.

2. The process of claim 1, wherein the water content removing step includes the step of heating the condensed oil within the range of 100 to 150 degrees Celsius.

3. The process of claim 1, wherein the heating step comprises the step of heating the yolk in the closed heating vessel within the range of 175 to 205 degrees Celsius to evaporate the oil therefrom.

4. The process of claim 1, including the step of administering the health supplement to a mammal.

5. The process of claim 1, including the step of selecting a manner of administering the health supplement to a mammal through various routes selected from the group consisting of one or more of the following: oral, buccal, sublingual, nasal, topical, transdermal, opthalmic, vaginal, rectal, intravesical, pulmonary, intra-arterial, intravenous, intradermal, intramuscular, subcutaneous, intraperitoneal, intrathecal and intraocular.

6. The process of claim 1, including the step of delivering the supplement to a mammal using a metered dose inhaler, a nebulizer, an atomizer, a spray bottle, or a nasal pump.

7. The process of claim 1, including the step of diluting one drop of the condensed oil with five gallons of water to form a mixture.

8. The process of claim 7, including the step of placing an additive into the mixture to bond with the oil.

9. A process for making a health supplement from an egg having a yolk and an egg white, comprising:
separating the egg yolk from the egg white;
placing at least a portion of the yolk in a closed heating vessel;
heating the yolk within the range of 175 to 205 degrees Celsius to evaporate an oil therefrom;
condensing the evaporated oil; and
removing at least a portion of water content from the condensed oil to form the health supplement by heating the condensed oil within the range of 100 to 150 degrees Celsius;
wherein the health supplement aids in at least one of the following: protecting treated surfaces, reducing oxidative stress, increasing efficiency of probiotic activity, reducing effects of acidosis, and maintaining blood pH.

10. The process of claim 9, including the step of administering the health supplement to a mammal.

11. The process of claim 9, including the step of selecting a manner of administering the health supplement to a mammal through various routes selected from the group consisting of one or more of the following: oral, buccal, sublingual, nasal, topical, transdermal, opthalmic, vaginal, rectal, intravesical, pulmonary, intra-arterial, intravenous, intradermal, intramuscular, subcutaneous, intraperitoneal, intrathecal and intraocular.

12. The process of claim 9, including the step of delivering the supplement to a mammal using a metered dose inhaler, a nebulizer, an atomizer, a spray bottle, or a nasal pump.

13. The process of claim 9, including the step of diluting one drop of the condensed oil with five gallons of water to form a mixture.

14. The process of claim 13, including the step of placing an additive into the mixture to bond with the oil.

15. A process for making a health supplement from an egg having a yolk and an egg white, comprising:
separating the egg yolk from the egg white;
placing at least a portion of the yolk in a closed heating vessel;
heating the yolk within the range of 175 to 205 degrees Celsius to evaporate an oil therefrom;
condensing the evaporated oil;
removing at least a portion of water content from the condensed oil to form the health supplement by heating the condensed oil within the range of 100 to 150 degrees Celsius;
selecting a manner of administering the health supplement to a mammal through various routes selected from the group consisting of one or more of the following: oral, buccal, sublingual, nasal, topical, transdermal, opthalmic, vaginal, rectal, intravesical, pulmonary, intra-arterial, intravenous, intradermal, intramuscular, subcutaneous, intraperitoneal, intrathecal and intraocular; and
administering the health supplement to the mammal;
wherein the health supplement aids in at least one of the following: protecting treated surfaces, reducing oxidative stress, increasing efficiency of probiotic activity, reducing effects of acidosis, and maintaining blood pH.

16. The process of claim 15, including the step of delivering the supplement to the mammal using a metered dose inhaler, a nebulizer, an atomizer, a spray bottle, or a nasal pump.

17. The process of claim 15, including the step of diluting one drop of the condensed oil with five gallons of water to form a mixture.

18. The process of claim 17, including the step of placing an additive into the mixture to bond with the oil.
